(19) United States
(12) Patent Application Publication
(10) Pub. No.: US 2009/0165120 A1
(43) Pub. Date: Jun. 25, 2009

(54) Mobile Terminal for a Traffic Information System, and Method for Activating an Access Control Device in a Mobile Terminal

(75) Inventor: Theodor Kamalski, Weert (NL)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/084,865

(22) PCT Filed: Sep. 3, 2007
(86) PCT No.: PCT/EP2007/059183

§ 371 Date: Jun. 26, 2008

(30) Foreign Application Priority Data
Sep. 5, 2006 (DE) 10 2006 041 577.9

(51) Int. Cl. H04L 9/32

(52) U.S. Cl. 726/17

(57) ABSTRACT

Disclosed is a mobile terminal characterized by a first manipulation unit (7) which is designed to modify control data (CD) contained in a received piece of traffic information (TI) in such a way that a decoding device (5) and an access control device (9) are activated by an evaluation unit (8) also when the traffic information (TI) has a non-encoded location designation (LC). The access control device (9) can thus use user control designed for encoded location data (cLC) also for traffic information services in which the location designations are not encoded.

The invention relates to a mobile terminal for a traffic information system for receiving and outputting location-based traffic information, the traffic information containing location statements in the form of location identifiers which are converted into intelligible location statements in the mobile terminal using a tabular map with location entries. The invention also relates to a method for activating an access control apparatus for a tabular map in a mobile terminal in a traffic information system.

In traffic information systems, current traffic information is transmitted from a transmission mobile to a mobile terminal, usually installed in a vehicle. The traffic information, also called traffic messages, can be output by the mobile terminal directly to a driver of the vehicle, provided for later or first retrieval or transferred to a system for the purpose of automatic journey route planning (navigation system).

A known traffic information system of this kind is the RDS-TMC (Radio Data System-Traffic Message Channel). In this system, the current traffic information is transmitted in digitally encoded form in an analog radio signal. On account of the low bandwidth which is available for the TMC channel in addition to the actual audio signal in the actual radio signal, location descriptors are not transmitted in plain text in the RMS-TMC system, but rather are referenced in line with the ISO 14819-3 standard using a two-byte identification number, the location identifier.

In such traffic information systems in which a location statement is provided in the form of a location identifier, converting the location identifier into an intelligible location statement requires a tabular map with location entries in the mobile terminal. Indexed according to the location identifier, the tabular map comprises important parameters for describing the location, including a location name in plain text, inter alia.

One country may have a plurality of tabular maps provided for it in parallel which are selected using selection numbers which are transmitted in addition to further control data for a location identifier as part of a piece of traffic information. Within a country, various service providers can act in parallel with one another, some services being provided at no cost and some being provided at a cost. In this context, many countries have general tabular maps used by several providers, service providers being able to access said maps using appropriate selection numbers associated with the tabular maps. Alternatively, service providers can request the use of separate, proprietary tabular maps from a management center stipulated for each country. When the proprietary tabular maps have been accessible to the mobile terminals, they are likewise addressed using their assigned selection numbers. Proprietary tabular maps are one way of providing access control for a cost-incurring information service. Only such terminals as have an appropriate proprietary tabular map are able to correctly output the traffic information transmitted by this service provider.

Responsibility for equipping terminals with the tabular maps frequently lies with the appliance manufacturer or else the automobile manufacturer. Depending on the use charge paid, the respective terminal comes with a data storage medium, for example a compact disk, with tabular maps, or these maps are stored in a memory in the respective terminal which is provided for this purpose. When the tabular map is updated, the appliance or car manufacturer needs to provide data storage media having the updated data on a customer- or terminal-specific basis or needs to store these updated data directly in the terminal, for example when the vehicle is inspected. This process is complex and accordingly costly.

As part of the RDS-TMC specification, the extension according to ISO 14819-6 has subsequently enabled an alternative form of access control. On the basis of this extension, location identifiers can be transmitted in encrypted form and decrypted in the terminal before they are converted into intelligible location statements using an appropriate tabular map. Furthermore, an access control apparatus is provided which is suitable for either permitting or preventing access to tabular maps on the basis of prescribed authorizations stored in a terminal. Only if use authorization has been given are decryption parameters, which are necessary for decrypting the location identifier, provided by the access control apparatus.

In this context, use authorizations can easily be prescribed and stored in the mobile terminal by virtue of the user of the mobile terminal inputting an appropriate enable code, for example, the enable code being delivered depending on the use charge paid. Maps which are protected against unauthorized access in this way can be provided in all mobile terminals regardless of use charges paid, and replaceable data storage media with update data for tabular maps can be forwarded to all customers without the risk of unauthorized use. The complex, customer-specific distribution process for tabular maps and their update data is dispensed with.

One problem in this context is that the access control method based on the ISO 18419-6 specification is linked to location entries transmitted in encrypted form. For reasons of backwards compatibility with existing systems, service providers which use proprietary tabular maps with location identification numbers transmitted in unencrypted form are frequently unwilling to change their transmission methods in line with the extension of the RDS-TMC method based on ISO 14819-6. The access control apparatus of mobile terminals based on this specification is therefore not available for such providers on the basis of the prior art.

It is therefore an object of the present invention to provide a mobile terminal for a traffic information system of the type cited at the outset which allows use of the access control method even when location identifiers are transmitted in unencrypted form. It is a further object of the invention to specify a method for activating an access control apparatus for a tabular map in a mobile terminal in a traffic information system which allows use of the access control apparatus even when location identifiers are transmitted in unencrypted form.

This object is achieved by the features of the independent claims. Further refinements of the invention are specified in the respective dependent claims.

In line with a first aspect, the object is achieved by a mobile terminal for a traffic information system which has a receiver for location-based traffic information, the traffic information TI comprising an unencrypted location identifier or an encrypted location identifier and control data. An evaluation unit for control data is provided, a memory facility for at least one tabular map with location entries, an access control apparatus which can be activated by the evaluation unit, and a decryption device which can be activated by the evaluation unit for the purpose of decrypting the encrypted location identifier. In this case, the access control apparatus is suitable for either permitting or preventing access to the at least one tabular map on the basis of prescribed use authorizations. The evaluation unit is set up such that the control data are taken as a basis for activating both the access control apparatus and the decryption device if the traffic information contains an encrypted location identifier, or for deactivating both if the traffic information contains an unencrypted location identifier.

The mobile terminal is distinguished by a first manipulation unit which is set up to alter the control data such that the evaluation unit activates the decryption device and the access control apparatus if the traffic information contains an unencrypted location identifier.

The effect achieved by manipulating the control data is that the access control apparatus can also be used for traffic information with an encrypted location identifier. This makes it an uncomplicated matter to expand the use control designed for encrypted location statements also for the services of service providers which are unable or do not wish to use encryption for location identifiers. An infrastructure linked to the use control for setting and updating use authorizations can equally be used at the same time. The mobile terminal is also fully compatible with existing traffic information systems, i.e. services with location identifiers transmitted in unencrypted or encrypted form can be used in the existing form.

In one advantageous refinement of the first aspect, a second manipulation unit is provided which is set up to put the decryption device into a special mode in which a location identifier which is output by the decryption device is identical to a location identifier which is supplied to the decryption device. This prevents an unencrypted location identifier from being altered by the decryption device, which would result in incorrect conversion of the location identifier by a tabular map which is not customized appropriately. The second manipulation unit therefore makes it possible to dispense with otherwise necessary customization of the location entries in a tabular map.

In another advantageous refinement of the first aspect, the first and/or the second manipulation unit can be activated and deactivated and a comparator for control data which is connected to the first and/or to the second manipulation unit is provided. The comparator is set up to compare received control data with prescribed control data and to take the result of the comparison as a basis for activating or deactivating the first and the second manipulation unit. This allows the manipulation of the control data and/or the decryption parameters to be directed specifically at certain services which can be identified using the control data.

In another advantageous refinement of the first aspect, the first manipulation unit is connected to the receiver and to the evaluation unit such that the control data received by the receiver can be altered by the first manipulation unit before they are routed to the evaluation unit. This arrangement of the unit allows the first manipulation unit in a mobile terminal to be used together with a receiver and an evaluation unit, which are standard units based on the prior art.

In another advantageous refinement of the first aspect, the mobile terminal is suitable for receiving and processing traffic information based on the RDS-TMC system. In particular, the mobile terminal is set up to receive control data which comprise a selection number and a further selection number for the purpose of selecting the tabular maps, the first manipulation unit storing a received value for the selection number as a further selection number and setting the selection number to the value zero for the purpose of altering the control data. In this way, the access control apparatus can be activated in the RDS-TMC system through simple manipulation of the control data.

In line with a second aspect, the object is achieved by a method for activating an access control apparatus for a tabular map in a mobile terminal in a traffic information system. In this case, the mobile terminal has the features described above. The method comprises the following steps. Traffic information, comprising an unencrypted location identifier or an encrypted location identifier and control data, is received. In this context, the control data indicate whether the traffic information contains an unencrypted location identifier or an encrypted location identifier. The control data are compared with prescribed control data. The result of the comparison is taken as a basis for altering the control data in a piece of traffic information which contains an unencrypted location identifier such that the control data indicate an encrypted location identifier. Next, the decryption device and the access control apparatus are activated if the control data indicate an encrypted location identifier.

In line with one advantageous development of the second aspect, the result of the comparison is taken as a basis for putting the decryption device into a special mode. In the special mode, a location identifier which is output by the decryption device is identical to a location identifier which is supplied to the decryption device.

In line with one advantageous development of the second aspect, the received control data comprise a selection number and a further selection number for selecting one of the tabular maps. To alter the control data, a received value for the selection number is stored as a further selection number and the selection number is set to the value zero. The advantages of the second aspect and of its developments correspond to those of the first aspect.

The invention is explained in more detail below using an exemplary embodiment with reference to three figures, in which:

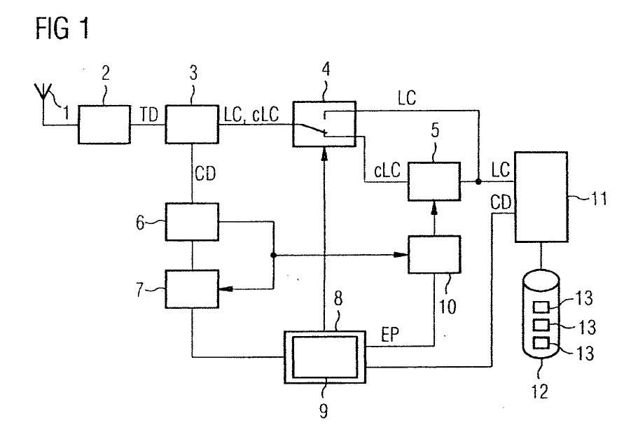

FIG. 1 shows a schematic illustration of a mobile terminal for a traffic information system,

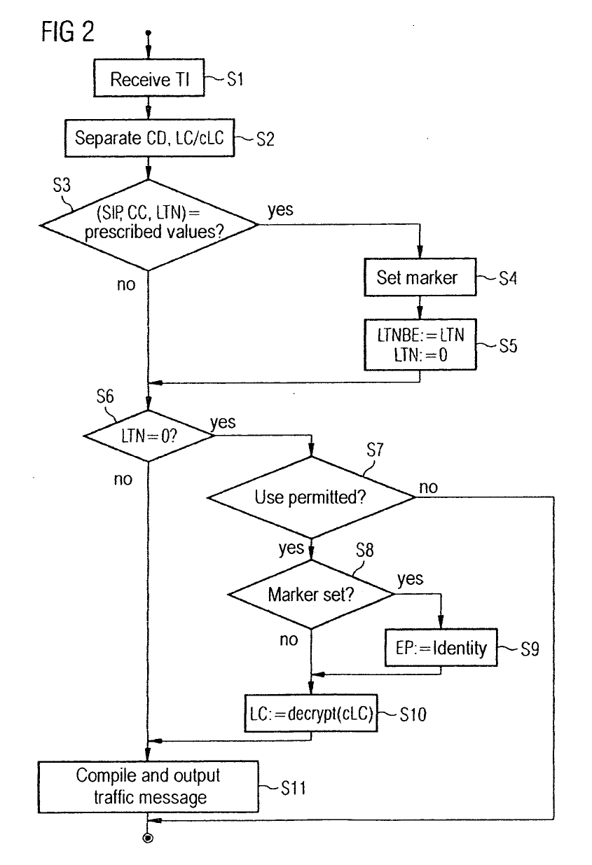

FIG. 2 shows a flowchart of a method for activating an access control apparatus for a tabular map, and

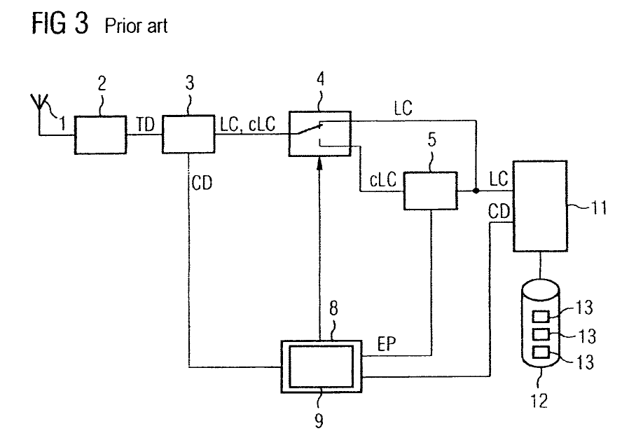

FIG. 3 shows a schematic illustration of a mobile terminal for a traffic information system based on the prior art.

FIG. 3 shows a mobile terminal for a traffic information system based on the prior art in a schematic illustration. A receiver 2 connected to an antenna 1 forwards traffic information TI to a separator 3. The separator 3 separates firstly location identifiers LC and encrypted location identifiers cLC and secondly control data CD from the traffic information TI. Location identifiers LC and encrypted location identifiers cLC are forwarded to a changeover switch 4 which is connected to a decryption unit 5. Control data CD are forwarded to an evaluation unit 8 which comprises an access control apparatus 9. For the purpose of controlling it, the evaluation unit 8 is connected to a changeover switch 4 and is also connected to the decryption unit 5 for the purpose of transmitting decryption parameters DP. Location identifiers LC are forwarded from the decryption unit 5 or from the changeover switch 4 to an output unit 11, as are the control data CD from the evaluation unit 8. The output unit 11 is connected to a memory 12 which contains tabular maps 13.

FIG. 3 shows a mobile terminal by way of example which is suitable for receiving and outputting traffic information TI based on the RDS-TMC standard. The receiver 2 is usually also suitable for receiving audio radio signals, which is not illustrated further in this case, however. The received traffic information TI comprises a multiplicity of pieces of information from which the separator 3 forwards the location identifier LC and the encrypted location identifier cLC to the changeover switch 4.

The other information which the traffic information TI contains is forwarded as control data CD to the evaluation unit 8. The control data CD are used, inter alia, to select a tabular map 13 which is suitable for converting the received location identifier LC. By way of example, the control data comprise a country identifier CC (Country Code), a service identifier SID (Service Identification) and a selection number LTN (Location Table Number) for tabular maps. Just from a received location identifier, it is not possible to tell whether this location identifier is encrypted or unencrypted. The type of location identifier is therefore indicated in the control data. When a location identifier is transmitted as an unencrypted location identifier LC, this is indicated by a selection number LTN>0 in a control data CD. When a location identifier is transmitted as an encrypted location identifier cLC, this is indicated in the control data CD by a selection number LTN=0 in line with the specification I-SO14819-6. In that case, the control data CD contain a further selection number LTNBE (Location Table Number Before Encryption) for the purpose of selecting the tabular map.

When the evaluation unit 8 recognizes an unencrypted location identifier from a selection number LTN>0 in the control data CD, it actuates the changeover switch 4 so that it adopts the position shown in FIG. 3. In this position, received location identifiers LC are forwarded directly to the output unit 11. Using the selection number LTN, the country code CC and possibly the service identifier SID, which are transmitted to the output unit 11 from the evaluation unit 8, the output unit 11 selects from the tabular maps 13 the one which is used to convert the location identifier LC into a clearly intelligible location descriptor. The control data CD also contain an event identifier which is converted into a traffic event in plain text on the basis of a prescribed event table (not shown here). This traffic event forms, together with the location statement, a traffic message which is output by the output unit 11 in the form of a voice message and/or as a visually displayed message.

The memory 12 for holding the tabular maps 13 may either be an internal memory, for example a nonvolatile memory based on flash technology, and/or a replaceable storage medium, for example a compact disk or a digital versatile disk (DVD) which is inserted into the mobile terminal. The number of tabular maps 13 is in this case not limited to the number of three maps shown by way of example in the figure, but rather is arbitrary in principle.

When a location identifier is transmitted as an encrypted location identifier cLC, this is indicated by a selection number LTN=0, as mentioned. In this case, the number of the tabular map 13 to be used is indicated by the additionally transmitted further selection number LTNBE. The evaluation unit 8 is set up to activate the access control apparatus 9 in such a case. As shown, this access control apparatus 9 may be arranged within the evaluation unit 8 or may be a stand-alone unit.

The access control apparatus 9 has access to access profiles stored in the mobile terminal. Access profiles are data records which store a use authorization for certain services, possibly including a validity period. Use authorizations in access profiles can easily be input or updated by the manufacturer, seller or user of the mobile terminal on the basis of paid use charges, for example by inputting code numbers or the like.

The association of an access profile with a received piece of traffic information TI is accomplished by comparing the received country identifier CC, the further selection number LTNBE and possibly the service identifier SID with appropriate values stored in the access profiles. If the mobile terminal is enabled for use of the relevant service, the access profile is also used to transfer stored decryption parameters DP to the decryption unit 5, which uses these decryption parameters DP to convert the encrypted location identifier cLC into an unencrypted location identifier LC. For the sake of completeness, it will be mentioned that in the case of the method used for RDS-TMC the decryption parameters are not stored directly in the access profiles, but rather are taken from a table row from one of several tables, the table being indicated in the access profile and the table row being determined from another transmitted parameter, called an encryption identifier. For the method illustrated, this intermediate step is insignificant, however.

Following the decryption of an encrypted location identifier cLC by the decryption unit 5, the decrypted location identifier is forwarded to the output unit 11 in similar fashion to the case of a location identifier LC transmitted in unencrypted form. Using a tabular map 13 determined by the control data CD, a traffic message is in turn compiled and output visually or audibly in plain text. As an alternative or in addition to the output of plain text, the traffic message can be transferred to a navigation system in a data format provided for this purpose. If the access control apparatus 9 establishes that the mobile terminal is not authorized to use the relevant service, then neither are suitable decryption parameters DP available nor are the control data CD forwarded to the evaluation unit 11, which prevents unauthorized use of the relevant service.

FIG. 1 shows a schematic illustration of an inventive mobile terminal in a traffic information system. Identical reference symbols in FIG. 1 and FIG. 3 denote elements which are the same, or which have the same effect.

In comparison with the mobile terminal from FIG. 3, the inventive mobile terminal shown in FIG. 1 differs by virtue of a comparator 6 and a first manipulation unit 7 and a second manipulation unit 10 connected thereto. The comparator 6 and the first manipulation unit 7 are arranged—in respect of the transfer path for the control data CD—between the separator 3 and the evaluation unit 8. The second manipulation unit 10 is arranged—in respect of the transfer path for the decryption parameters DP—between the evaluation unit 8 and the decryption unit 5. In alternative refinements of the mobile terminal, the comparator 6 may naturally also be implemented within a unit in combination with the first manipulation unit 7. The comparator 6 and the first and/or second manipulation unit 7, 10 may be in the form of either hardware components or software components.

The comparator 6 is set up to use service identifier SID, country identifier CC and the selection number LTN to identify prescribed services from certain service providers in certain countries. For this purpose, a list containing the relevant values for service identifier SID, country identifier CC and the selection number LTN of the services to be identified may be prescribed for the comparator 6. The list should comprise all services for which terminal-end access control is desired but not provided, that is to say particularly cost-incurring services for which a location identifier is transmitted as an unencrypted location identifier LC and for which the access control, as described in connection with FIG. 3, is thus not available. For these services, possible access control merely involves making proprietary tabular maps which are used by the relevant service provider available only to mobile terminals which are authorized for use.

The comparator 6 activates the first and second manipulation units 7 and 10 when the comparator 6 recognizes such a service provider from stored values for service identifier SID, country identifier CC and the selection number LTN. In one alternative refinement, provision may be made for the comparator 6 to use not only the country identifier CC but possibly also what is known as an extended country identifier (Extended Country Code—ECC) for the purpose of service identification. The extended country identifier is an additional identifier which is specified in the RDS-TMC system and which extends the number of encodable countries in comparison with the country identifier CC. In addition, further information can be evaluated which provides information about the country in which the traffic information TI is received and for which it therefore presumably applies. Such information can be provided for the mobile terminal, e.g. by a GPS (Global Positioning System) receiver.

The first manipulation unit 7 is set up to alter values for the control data CD, particularly for the selection number LTN and the further selection number LTNBE, before the values are passed to the evaluation unit 8. The second manipulation unit 10 is set up to alter values for the decryption parameters DP before they are transmitted from the evaluation unit 8 or the access control apparatus 9 to the decryption unit 5.

An exemplary embodiment of the inventive method for activating an access control apparatus for a tabular map in a mobile terminal in a traffic information system, such as could be carried out by the mobile terminal shown in FIG. 1, for example, is described in more detail below in connection with the block diagram from FIG. 2.

In a first step S1, traffic information TI is received. In a subsequent step S2, control data CD are extracted from the traffic information TI and forwarded to a comparator, for example the comparator 6 from FIG. 1. The comparator 6 compares a service identifier SID, a country code CC and a selection number LTN, which the control data CD contain with appropriate entries from a prescribed list. If the received combination of service identifier SID, country identifier CC and selection number LTN is held in the prescribed list, the method branches to a step S4.

In step S4, a marker (flag) is set which stores the match found in step S3 for later use. In addition, in a step S5, the received value for the selection number LTN is adopted as the value for the further selection number LTNBE, and the value for the selection number LTN is set to zero. In the exemplary embodiment in FIG. 1, this change to the control data CD is made by the first manipulation unit 7. The method is then continued with a step S6. If a match has not been found between the received parameters and the stored parameters in step S3, the method is likewise continued with step S6 by omitting steps S4 and S5.

Step S6 evaluates whether the stored selection number is LTN=0. If the selection number LTN=0, the method branches to a step S7, otherwise it branches to a step S11. Step S7 uses prescribed access profiles to ascertain whether the service denoted by country identifier CC, service identifier SID and other selection numbers LTNBE is enabled for use on the respective mobile terminal. If not, the method ends. If the relevant service is enabled, decryption parameters DP are provided for decryption on the basis of the stored access profile.

The method then branches to a step S8, in which the state of the marker possibly set in step S4 is requested. If the marker has been set, the method branches to a step S9, in which the decryption parameters DP are set to a prescribed value indicating a special mode. The method then branches to a step S10, in which the encrypted location identifier cLC is converted into an unencrypted location identifier LC using the decryption parameters DP. In the exemplary embodiment in FIG. 1, this decryption is performed by the decryption unit 5. In this case, the decryption unit 5 is set up such that it does not perform decryption for a decryption parameter DP which corresponds to the prescribed value for the special mode, and therefore the location identifier output by the decryption unit 5 is identical to the location identifier supplied to the decryption unit 5. This special mode is provided as standard for test purposes for the RDS-TMC traffic information system as part of the specification ISO 14819-6. Following decryption or supposed decryption of the received location identifier by the decryption unit 5, the method is continued with the step S11.

In step S11, the control data are used to select one of the tabular maps 13, which is used to convert the decrypted location identifier LC into a location statement in plain text, so that a traffic message can be compiled and output. In addition to the conversion and output in plain text, it is in turn alternately or additionally possible to convert and transfer the traffic message to a navigation system in a data format provided therefor. In the exemplary embodiment in FIG. 1, step S11 is carried out by the output unit 11 together with the memory 12 and the tabular maps 13 contained therein.

The effect achieved by the inventive method is that, for traffic information from service providers which are stored in the prescribed list of the comparator 6, the access control, which is not accessible for location identifiers transmitted in unencrypted form on the basis of the standardized version of an RDS-TMC compatible mobile terminal, is rendered accessible. The activation of the decryption unit, which is linked to the activation of the access control apparatus, is not prevented but continues to have no effect on the transmitted location identifier on account of the use of the special mode provided for test purposes.

In one alternative refinement of the mobile terminal, the second manipulation unit 10 can be dispensed with. In such a case, the proprietary tabular map 13 which the manufacturer has provided with unencrypted location identifiers would need to be subjected to encryption before being used in the mobile terminal, e.g. performed by the mobile terminal's manufacturer which is responsible for providing the tabular maps in the mobile terminal. The associated access profile would need to store the same decryption parameters which were used to modify the tabular map. An unencrypted location identifier LC transmitted by the service provider as part of traffic information TI would then be processed, i.e. in this case encrypted instead of decrypted, by the decryption unit 5 using the provided decryption parameters and would be converted precisely such that the processed location identifier indicates the correct entry in the encrypted tabular map. This is possible because the encryption and decryption method within the context of the ISO 14819-6 specification is a symmetrical permutation method which is a unique mapping provision between unencrypted and encrypted values.

The solution presented has, in particular, the advantage that the inventive mobile terminal is based on a multiplicity of known and proven components. The way in which these individuals components work, for example the evaluation unit 8, the access control apparatus 9 and the decryption unit 5, is unchanged, but the interaction of these components is altered by the added components comparator 6, first manipulation unit 7 and second manipulation unit 10 such that activation of the access control apparatus 9 also becomes possible for location identifiers transmitted in unencrypted form. The service provider responsible for providing the tabular maps 13 of the mobile terminal, that is to say the manufacturer of the mobile terminal, for example, can provide tabular maps 13 uniformly for all mobiles terminals and customers, regardless of the specific, terminal-based use authorization for these maps. Use control is possible in uniform fashion, i.e. as in the case of those service providers which transmit their traffic information with encryption location identifiers, using the access profiles.

1.-9. (canceled)

10. A mobile terminal for a traffic information system, comprising:
a receiver for location-based traffic information, the traffic information comprising control data and one of an unencrypted location identifier or an encrypted location identifier;
an evaluation unit for evaluating the control data;
a memory facility storing at least one tabular map containing location entries;
an access control apparatus activatable by the evaluation unit and configured to permit or prevent access to the at least one tabular map based on prescribed use authorization;
a decryption device activatable by the evaluation unit for decrypting the encrypted location identifier, the evaluation unit configured to utilize the control data to one of activate the access control apparatus and the decryption device if the traffic information contains an encrypted location identifier and deactivate the access control device and the decryption device if the traffic information contains an unencrypted location identifier; and
a first manipulation unit configured to alter the control data such that the evaluation unit activates the decryption device and the access control apparatus if the traffic information contains an unencrypted location identifier.

11. The mobile terminal as claimed in claim 10, further comprising a second manipulation unit configured to switch the decryption device into a special mode in which a location identifier output by the decryption device is identical to the location identifier which is supplied to the decryption device.

12. The mobile terminal as claimed in claim 11, further comprising:
a comparator connected to at least one of the first manipulation unit and the second manipulation unit, the comparator being configured to compare received control data with prescribed control data and to one of activate and deactivate the first and the second manipulation unit based on the comparison;
wherein at least one of the first manipulation unit and the second manipulation unit is activatable and deactivatable.

13. The mobile terminal as claimed in claim 10, wherein the first manipulation unit is connected to the receiver and the evaluation unit such that the control data received by the receiver is alterable by the first manipulation unit before being routed to the evaluation unit.

14. The mobile terminal as claimed in claim 10, wherein the mobile terminal is configured to receive and process traffic information in accordance with a Radio Data System-Traffic Message Channel system.

15. The mobile terminal as claimed in claim 14, wherein the receiver is configured to receive control data which comprise a first selection number and a second selection number for selecting the at least one tabular map; and
wherein the first manipulation unit is configured to store a received value for the first selection number as a second selection number and to set the first selection number to a value of zero for altering the control data.

16. A method for activating an access control apparatus for a tabular map in a mobile terminal in a traffic information system, wherein the mobile terminal comprises a receiver for location-based traffic information, the traffic information comprising one of an unencrypted location identifier, an encrypted location identifier and control data, a memory facility for at least one tabular map containing location entries, an access control apparatus which is activatable by the evaluation unit and which is confirming to permit or prevent access to the at least one tabular map based on prescribed use authorization, a decryption device which is activatable by the evaluation unit for decrypting the encrypted location identifier, a comparator for the control data, and a first manipulation unit for the control data, the method comprising the steps of:
receiving traffic information comprising control data and one of an unencrypted location identifier or an encrypted location identifier, the control data indicating whether the traffic information contains one of the unencrypted location identifier and the encrypted location identifier;
comparing the control data with prescribed control data;
altering the control data in a segment of traffic information which contains the unencrypted location identifier based on the comparison such that the control data indicate an encrypted location identifier; and
activating the decryption device and the access control apparatus if the control data indicate the encrypted location identifier.

17. The method as claimed in claim 16, further comprising the step of:
switching the decryption device into a special mode in which a location identifier output by the decryption device is identical to the location identifier supplied to the decryption device base.

18. The method as claimed in claim 16, wherein the received control data comprise a first selection number and a second selection number for selecting one of the tabular maps; and
wherein a received value for the selection number is stored as the second selection number and the first selection number is set to a value of zero for altering the control data.

19. The method as claimed in claim 17, wherein the received control data comprise a first selection number and a second selection number for selecting one of the tabular maps; and
wherein a received value for the selection number is stored as the second selection number and the first selection number is set to a value of zero for altering the control data.

20. A method for activating an access control apparatus for a tabular map in a mobile terminal in a traffic information system, the method comprising the steps of:
receiving traffic information comprising control data and one of an unencrypted location identifier or an encrypted location identifier, the control data indicating whether the traffic information contains one of the unencrypted location identifier and the encrypted location identifier;
comparing the control data with prescribed control data;
altering the control data in a segment of traffic information which contains the unencrypted location identifier based on the comparison such that the control data indicate an encrypted location identifier; and
activating a decryption device and an access control apparatus if the control data indicate the encrypted location identifier.
